(19) United States
(12) Patent Application Publication
(10) Pub. No.: US 2025/0360037 A1
(43) Pub. Date: Nov. 27, 2025

(54) OVERHEAD HANDLE SYSTEM FOR TRANSFERRING PERSON WITH REDUCED MOBILITY

(71) Applicant: Delta Air Lines, Inc., Atlanta, GA (US)

(72) Inventor: Vipula Dasanayaka, Greensboro, NC (US)

(21) Appl. No.: 18/919,746

(22) Filed: Oct. 18, 2024

Related U.S. Application Data
(60) Provisional application No. 63/651,704, filed on May 24, 2024.

(51) Int. Cl. A61G 7/10

(52) U.S. Cl. CPC A61G 7/1007; A61G 7/1019

(57) ABSTRACT

An overhead handle system that accommodates a person with reduced mobility (PRM) in a PRM device (wheelchair) in an interior space such as an aircraft lavatory. More specifically, the system is provided which includes a grab handle and a driving mechanism. The grab handle is configured to be attached to a ceiling of a housing and to move from a stowed position in which the grab handle is positioned along a wall of the housing to a deployed position in which the grab handle is configured to extend vertically from the ceiling of the housing to be accessible overhead by a person in a seated position. The driving mechanism is configured to slide the grab handle between the stowed position and the deployed position.

### CROSS-REFERENCE TO RELATED APPLICATION

This application claims the benefit of priority under 35 U.S.C. § 119(e) to U.S. Provisional Application No. 63/651,704, filed on May 24, 2024, which is hereby incorporated by reference in its entirety.

### BACKGROUND

A person with reduced or restricted mobility (PRM) who uses a wheelchair may need various accommodations, such as in transportation vehicles (trains, airplanes, buses, etc.). Many transportation vehicles do not have the appropriate accommodations. For example, a PRM often encounters difficulties when transferring from a PRM device such as a wheelchair, into a seat in transportation vehicles or public places. It is even more challenging to deploy accommodations for PRMs in tight spaces such as restrooms in transportation vehicles.

### BRIEF DESCRIPTION OF THE DRAWINGS

FIG. 1 is a diagram illustrating a lavatory with an overhead handle system that accommodates a PRM, according to an example embodiment.

FIGS. 2A and 2B are diagrams illustrating components of the overhead handle system of FIG. 1 in which an overhead grab handle is in a deployed position and in a stowed position, respectively, according to an example embodiment.

FIG. 3 is a diagram illustrating an interior space of a housing in which an overhead handle system of FIG. 1 includes one or more switches to activate deployment and retraction of an overhead grab handle, according to an example embodiment.

FIG. 4 is a diagram illustrating an environment in which the overhead grab handle of FIGS. 2A and 2B is deployed in a position easily accessible to a PRM in a PRM device, according to an example embodiment.

FIG. 5 is a diagram illustrating components of the overhead handle system of FIG. 1 in more detail, according to an example embodiment.

FIG. 6 is a diagram illustrating components of a height adjustment assembly that vertically adjusts a grab handle to accommodate a person in a seated position when the grab handle is already in a deployed position, according to an example embodiment.

FIG. 7 is a side view illustrating an accommodation system that includes the height adjustment assembly of FIG. 6 and a grab handle in a stowed position, according to an example embodiment.

FIGS. 8A and 8B are diagrams illustrating a perspective view and a side view, respectively, of the overhead grab handle of FIG. 7 in a deployed position with a height adjuster set in a standard position, according to an example embodiment.

FIGS. 9A and 9B are diagrams illustrating a perspective view and a side view, respectively, of the overhead grab handle of FIG. 7 in a deployed position with the height adjuster set at an extended height, according to an example embodiment.

FIG. 10 is a flowchart illustrating a method of deploying a grab handle of FIGS. 1, 2A, 2B, 3-7, 8A, 8B, 9A and 9B to accommodate a person in a seated position to transfer to another seat in an interior space, according to an example embodiment.

FIG. 11 is a hardware block diagram of a controller that may control operations of an overhead handle system, according to various example embodiments.

### DESCRIPTION OF EXAMPLE EMBODIMENTS

### Overview

Briefly, an overhead handle system is provided that accommodates a person with reduced mobility (PRM) in an interior space such as an aircraft lavatory, according to example embodiments.

More specifically, in one form, a system is provided, which includes a grab handle configured to be attached to a ceiling of a housing and to move from a stowed position in which the grab handle is positioned along a wall of the housing to a deployed position in which the grab handle is configured to extend vertically from the ceiling of the housing to be accessible overhead by a person in a seated position and a driving mechanism configured to slide the grab handle between the stowed position and the deployed position.

In another form, a method is provided. The method includes obtaining a signal requesting a deployment of a grab handle in an interior space and deploying a grab handle, using a driving mechanism and in response to the signal, by sliding the grab handle from a stowed position in which the grab handle is positioned along a wall of a housing of the interior space to a deployed position in which the grab handle protrudes downwards from a ceiling of the housing to be accessible overhead by a person in a seated position.

In yet another form, an accommodation system is provided. The accommodation system includes a housing having a plurality of side walls, a ceiling, and a seat in an interior space formed by the housing and an overhead grab handle mechanism. The overhead grab handle mechanism includes a grab handle attached to the ceiling and a driving mechanism that slides the grab handle between a stowed position in which the grab handle is positioned along one of the plurality of side walls of the housing and a deployed position in which the grab handle protrudes downwards from the ceiling to be accessible by a person in a seated position.

### EXAMPLE EMBODIMENTS

It is not unusual for a person with reduced or restricted mobility (PRM) to avoid public or private spaces that lack special accommodations for their PRM devices. PRM devices aid transport or movement of a person. The PRM devices come in a variety of sizes and formats to meet specific needs of their users. For example, the PRM devices include but are not limited to wheelchairs, strollers, scooters, etc.

While some seating areas have a space for the PRM device, and even include securing mechanisms to secure the PRM device in place, more is needed. Various challenges are encountered by PRMs in small spaces e.g., in a transportation vehicle. For example, it can be challenging for a PRM to transfer from the PRM device to another seat such as a toilet seat in a lavatory of a transportation vehicle, such as an aircraft, train or bus. A common design for accommodating a PRM to transfer from a wheelchair to a toilet seat in an aircraft lavatory is to have the PRM grab an edge of a sink counter and, if available, a wall mounted grab handle, and lift and pivot oneself from the PRM device (e.g., the wheelchair) to the toilet seat. This is nearly impossible for many PRMs (wheelchair bound passengers), forcing them to either use a second person's assistance, or to avoid using the toilet in the transportation vehicle.

A permanently mounted grab handle is not possible in small spaces. The permanently mounted grab handle, while it can provide some convenience for a PRM, can also be an obstacle and a hazard for any non-PRM user since such handle would be mounted at a much lower location than the head height of a standing person (non-PRM user). This becomes even more hazardous in tight spaces such as lavatories that accommodate PRM users and other users (non-PRM users). Grab or grip handles, which are mounted along a side wall of a bathroom stall, do not adequately accommodate a PRM because many PRMs do not have the strength to push themselves up. These maneuvers are further complicated by a lack of space (e.g., in a lavatory) and turbulence of a moving transportation vehicle.

A removable grab handle would require securing by a second person or an assistant prior to the PRM using the lavatory, and then removed and stored after it has been used. This option is cumbersome at best and impractical at times. Also, a removable grab handle is unlikely to support the weight of a PRM.

In short, conventional grab handles do not provide adequate accommodations for PRMs in tight spaces such as a lavatory of an aircraft. A grab handle that supports the weight of a PRM would be more helpful, allowing the PRM to grab the handle and simply pivot onto the toilet seat without any additional maneuvers. Further, the risk of falling because of turbulence is reduced. A load supporting grab handle, however, restricts how and where the grab handle may be installed so as not to obstruct use by non-PRM users (users that walk into the interior space).

In one or more example embodiments, a system is provided that includes a grab handle and a driving mechanism. The grab handle is configured to be attached to a ceiling of a housing (of an interior space, such as a lavatory) and to move from a stowed position in which the grab handle is positioned along a wall and/or a ceiling of the housing to a deployed position in which the grab handle is configured to extend vertically from the ceiling of the housing to be accessible overhead by a person in a seated position. The driving mechanism is configured to slide or rotate the grab handle in an arc between the stowed position and the deployed position. The grab handle is a load bearing, overhead handle that a PRM may use to pivot from a PRM device onto a toilet seat in a tight space such as a lavatory of a transportation vehicle. The driving mechanism retracts the grab handle after use so as not to obstruct access to a non-PRM user.

Additionally, in one or more example embodiments, the retractable grab handle is further configured to adjust to various heights to accommodate various PRMs and different PRM devices. For example, based on detecting a presence of a PRM in a PRM device, the control system activates a driving mechanism. The driving mechanism drives the grab handle, causing it to slide at an arc from a stowed position along a wall of the housing to a deployed position in which it protrudes downward from the ceiling at a height accessible by various PRMs in various PRM devices.

In one or more example embodiments, the grab handle is unique from other handles found within the transportation industry. For example, metal or leather handles typically found in trains or buses are located at a height that is practically impossible for a PRM in a seated position to access. According to one or more example embodiments, the grab handle is designed for special needs of PRMs, supports their weight (e.g., up to 300 pounds), and is presented at a convenient height for the PRM, yet the position in the space where it is installed is safer and convenient for all users of an interior space such as the transportation vehicle lavatory. For example, when not in use by a PRM, the grab handle is stowed away in a stowage compartment, formed inside a side wall of an interior space of the housing, in a diagonal position with respect to the ceiling of the interior space for compactness.

While example embodiments described below relate to the aircraft lavatory i.e., an aircraft toilet seat, the disclosure is not limited thereto and is applicable to other vehicles (e.g., cars, trains, buses, recreation vehicles, etc.) and/or places (e.g., theaters, auditoriums, stadiums, a toilet in a residential house, etc.). The system described in one or more example embodiments may be deployed in areas that need to be adjusted to accommodate a PRM in a PRM device. The system may be especially beneficial for tight interior spaces where a PRM needs to transfer from a PRM device into another seat such as the toilet seat. For example, the seat or toilet seat may be in a vehicle such as a public transportation vehicle (bus, minivan, etc.) or a boat, cruise ship, motorboat, etc. As another example, the seat may be in an airplane, etc. Deployments of systems and/or methods described below may depend on a use case scenario.

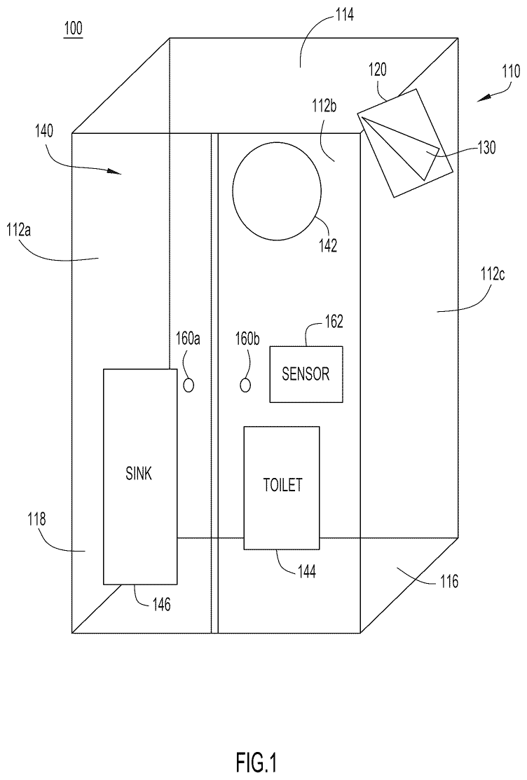

FIG. 1 is a diagram illustrating a lavatory 100 with an overhead handle system that accommodates a PRM (not shown), according to an example embodiment. The lavatory 100 includes a housing 110, a handle stowage compartment 120 (handle storage compartment), and an overhead handle system 130. The housing 110 includes walls 112a-c, a ceiling 114, a floor 116, and a door 118. The housing 110 forms an interior space 140 that has a porthole 142, a toilet 144, and a sink 146.

The notations 1, 2, 3 . . . n; a, b, c, . . . n; “a-n”, “a-d”, “a-f”, “a-g”, “a-b”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

The housing 110 forms the interior space 140 that has the toilet 144 and the sink 146 for use by any users (PRM users and passengers with unrestricted mobility). The interior space 140, using the overhead handle system 130, is configured to accommodate an independent transfer of the PRM from a PRM device onto the toilet 144 and back into the PRM device. Other interior spaces are within the scope of this disclosure. The toilet 144 and the sink 146 may be attached to the floor 116 and abut one or more of the walls 112a-c.

The walls 112a-c may include a first side wall 112a, a second side wall 112c, and a back wall 112b, which may or may not have the porthole 142. One of the walls 112a-c may include the handle stowage compartment 120, which is configured to store a grab handle of the overhead handle system 130. For example, the grab handle is stored in a diagonal position with respect to the ceiling to save space. As another example, the grab handle may align along a slanted side wall of the interior space. As such, when the lavatory 100 is not being used by a PRM, the grab handle of the overhead handle system 130 is stored or stowed away in the handle stowage compartment 120 so as not to obstruct access for non-PRM users (e.g., passengers with unrestricted mobility).

The handle stowage compartment 120 may be formed at the second side wall 112c and/or the ceiling 114. The handle stowage compartment 120 is configured to store the grab handle along the second side wall 112c and in a diagonal position with respect to the ceiling 114. In particular, the second side wall 112c may include a cavity or an opening configured to hold the grab handle fully therein in the diagonal orientation. In one example embodiment, the grab handle is configured to not protrude from the second side wall 112c into the interior space 140 in the stowed position when stored in the handle stowage compartment 120.

The interior space 140 may include another opening (in the second side wall 112c and/or the ceiling 114) for allowing the grab handle to be attached to the ceiling 114 e.g., via hinges such as a standalone hinge and another hinge that is adjacent to a driving mechanism for the grab handle. Since the grab handle accommodates the weight of the PRM, the grab handle is securely attached to a supporting structure such as the ceiling 114 or a frame of the housing 110. This is just one example of the lavatory 100 and the disclosure is not limited thereto.

The door 118 includes two door panels 160a-b such as a first door panel 160a (the main door panel) and a second door panel 160b (an additional door panel). This is provided by way of an example and not by way of a limitation. The door 118 may include more than two panels 160a-b (e.g., 3, 4, etc.) or even one panel (e.g., that is foldable). Since typical lavatory doors in aircrafts are not sufficiently wide to admit a PRM sitting in a PRM device such as a wheelchair, the second door panel 160b is added to allow entry of the PRM in the PRM device (e.g., an onboard wheelchair “OBW”) into the lavatory 100.

In one example embodiment, the second door panel 160b may include a sensor 162 (detector) to detect if a PRM in the PRM device is entering through the door 118 e.g., to use the toilet 144 and/or the sink 146. The sensor 162 may be configured to detect an opening of the second door panel 160b, which opens along with the first door panel 160a, to allow entry of the PRM device into the interior space 140. As another example, the sensor 162 may be a motion sensor that produces a signal indicating an opening of the second door panel 160b. Based on the signal generated by the sensor 162 and provided to a controller of the overhead handle system 130, the overhead grab handle may be automatically deployed.

The sensor 162, however, may take a variety of forms such as an optical sensor, magnetic sensor, camera(s), etc. For example, the sensor 162 may include one or more cameras that sense an environment in front of the door 118 and may detect a PRM device. The sensor 162 then communicates the detected environment (e.g., the PRM device) to a controller. However, in one or more example embodiments, the use of a camera should be avoided for privacy, and other sensors are deployed and are coupled to the controller.

In one example embodiment, the sensor 162 may initiate both deployment and retraction of the grab handle based on detecting a PRM device. However, for safety reasons, automated deployment of the grab handle may be avoided. In other words, additional actions may be required to deploy the grab handle. For example, when the second door panel 160b is opened (or closed depending on a particular use case scenario), this signals to a control system of the overhead handle system 130 to allow for activation of the grab handle i.e., an indication that a driving mechanism may be enabled to deploy the grab handle, at a user's request. Automatic retraction of the grab handle may be permitted (without obtaining a signal requesting a retraction of the grab handle). That is, opening and closing of the second door panel 160b may allow for a deployment of the grab handle a and/or initiate a retraction of the grab handle. The grab handle may be locked in place in the handle stowage compartment 120 when the lavatory 100 is being used by the non-PRM passenger (deployment is disabled). When the lavatory 100 is being used by a non-PRM passenger, only the first door panel 160a is used (opened and closed) and the grab handle of the overhead handle system 130 remains in the stowed (stored) position. The overhead handle system 130 is not visible to the non-PRM passenger and does not obstruct their use of the lavatory 100.

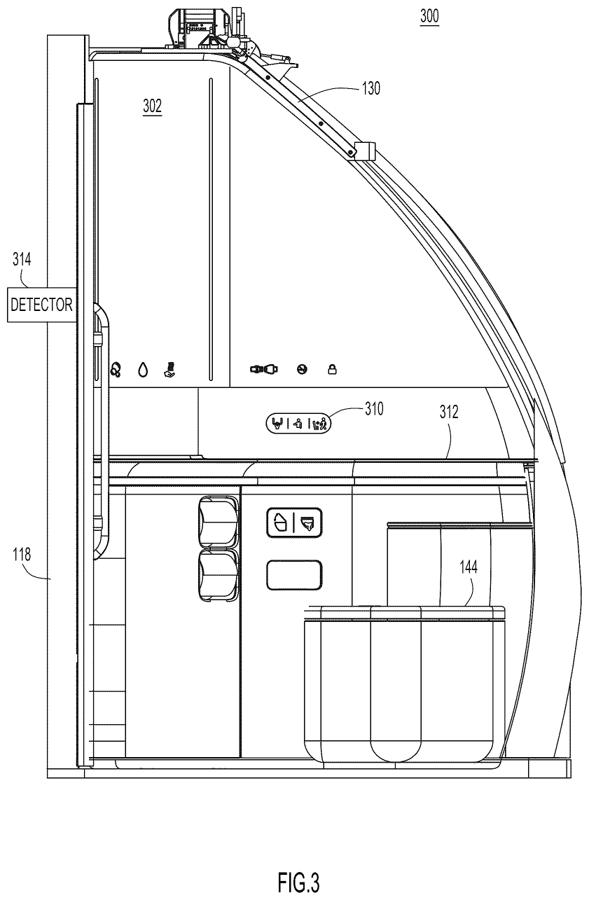

In another example embodiment, an activation switch may be provided (example shown in FIG. 3) instead of (or in addition to) the sensor 162. The activation switch may be conveniently location at a shoulder height of a person in a seating position. The PRM user presses the activation switch or an activation button to deploy the overhead grab handle. That is, the deployment of the overhead grab handle may be manual e.g., by manipulating an interior switch or by pressing an actuation button. As another example embodiment, a touchless switch may be provided that detects motion from a PRM user. The PRM user may manipulate an interior switch to request a deployment of the grab handle e.g., by simply waving their hand in front of the touchless switch to initiate the deployment of the overhead grab handle.

In yet another example embodiment, an activation button may be provided in the interior space to request a deployment of the overhead grab handle. When the activation button is pressed (manipulated by a user), a signal is obtained by the controller to initiate a deployment and/or to initiate a retraction of the grab handle.

In yet another example embodiment, the sensor 162 may be used to enable or disable the activation switch e.g., an activation button. That is, unless the sensor 162 detects presence of a PRM device, the activation switch or button is disabled. Using the sensor 162 on the door 118 to disable or enable the activation switch or button, ensures safety to non-PRM passengers that may be in a standing position in the lavatory 100 e.g., walking in, washing hands, etc.

These are just some examples of initiating the deployment of the grab handle. The disclosure is not limited to these examples. As noted above, automated deployment of a grab handle may be avoided due to safety concerns by using a motion detection on a second door panel. The grab handle is then deployed based on an input from an occupant of the lavatory 100 (the user requests deployment of the grab handle) while automatic retraction may still occur e.g., based on the door 118 or a motion sensor in the lavatory 100 (without user manipulation).

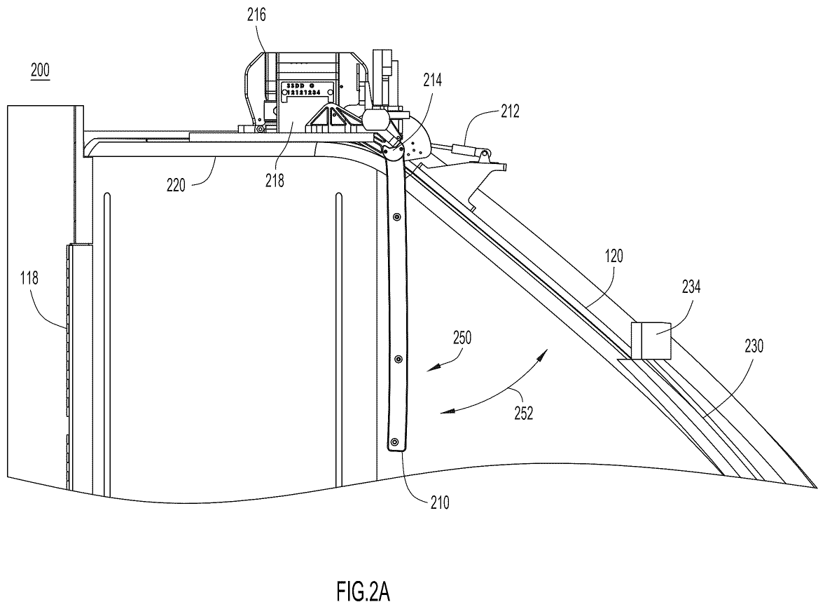

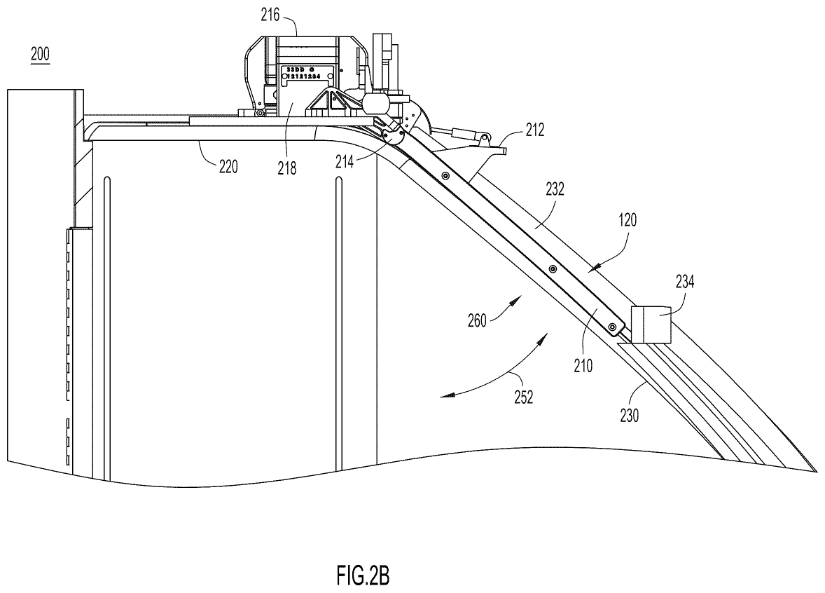

With continued reference to FIG. 1, FIGS. 2A and 2B are diagrams illustrating components 200 of the overhead handle system 130 of FIG. 1 in which an overhead grab handle is in a deployed position and in a stored position, respectively, according to an example embodiment.

The components 200 of the overhead handle system 130 include an overhead grab handle 210, a shock absorber and a spring damping system 212, one or more hinges 214 (e.g., a standalone hinge and a hinge that is formed with a driving mechanism 216), and a control system 218. The overhead grab handle 210 is attached to a lavatory ceiling 220 (such as the ceiling 114 of FIG. 1) and is stowed in the handle stowage compartment 120 that is positioned along the outer wall 230 that corresponds to the second side wall 112c of FIG. 1. In FIG. 2A, the overhead grab handle 210 is depicted in a deployed position 250 and in FIG. 2B, the overhead grab handle 210 is depicted in a stowed position 260.

The overhead handle system 130 is activated to release the overhead grab handle 210 from the stowed position 260 along the outer wall 230 into the deployed position 250 in which the overhead grab handle 210 is configured to extend vertically from the lavatory ceiling 220 to be accessible overhead by a person in a seated position. The overhead grab handle 210 protrudes downwards between the door 118 and the toilet 144 (shown in FIG. 1) at a height reachable by a PRM in a PRM device such as an OBW.

The overhead grab handle 210 includes a frame and an intermediate bar for grabbing by one or two hands of the user (e.g., the PRM). The design of the overhead grab handle 210 may vary based on a particular use case scenario. For example, the overhead grab handle 210 may include a separate handle for each hand while being supported by a single frame. While the overhead grab handle 210 is depicted in a rectangular shape, this is just an example. The overhead grab handle 210 may be oval, circular, square, etc. depending on a particular use case scenario. The overhead grab handle 210 may include two grab handles with two separate frames.

In one example embodiment, the overhead grab handle 210 is attached to the lavatory ceiling structure i.e., the lavatory ceiling 220 using the one or more hinges 214, such as a standalone hinge and a hinge adjacent to the driving mechanism 216. In one example embodiment, the overhead grab handle 210 is firmly attached to a frame of the housing above the lavatory ceiling 220 using the one or more hinges 214. The one or more hinges 214 ensure that the overhead grab handle 210 is firmly locked or secured in place (without movement). This ensures safety to the PRM that is using the overhead grab handle 210.

The overhead grab handle 210 is supported by a shock absorber and a spring damping system 212 to limit the speed of deployment and retraction of the overhead grab handle 210 and to provide a comfortable and secure assist handle for the PRM user. The shock absorber and a spring damping system 212 ensures that the overhead grab handle 210 slides at a predetermined stable speed i.e., ensures a relatively slow retraction and deployment e.g., within a predetermined period of time such as two to three seconds. In the deployed position 250, motion of the overhead grab handle 210 may be damped by the spring damping system 212. The overhead grab handle 210 is also connected to the driving mechanism 216.

The driving mechanism 216 is configured to slide the overhead grab handle 210 between the stowed position 260 in which the overhead grab handle 210 is stored in the handle stowage compartment 120 along the outer wall 230 of the lavatory 100 (FIG. 2B) and the deployed position 250 (FIG. 2A). That is, the driving mechanism 216 moves or slides the overhead grab handle 210 at an arc 252, from the handle stowage compartment 120 to the deployed position 250 in which it extends vertically down from the ceiling of the housing in a proximity of a toilet seat (not shown). Even in the deployed position 250, the overhead grab handle 210 may be allowed some degree of motion e.g., damped motion. An actuation motor of the driving mechanism 216 slides the overhead grab handle 210 within a predetermined period of time. For example, a gear and belt reduction assembly may reduce the speed of the actuation motor so that it deploys or retracts within a time period of two or three seconds.

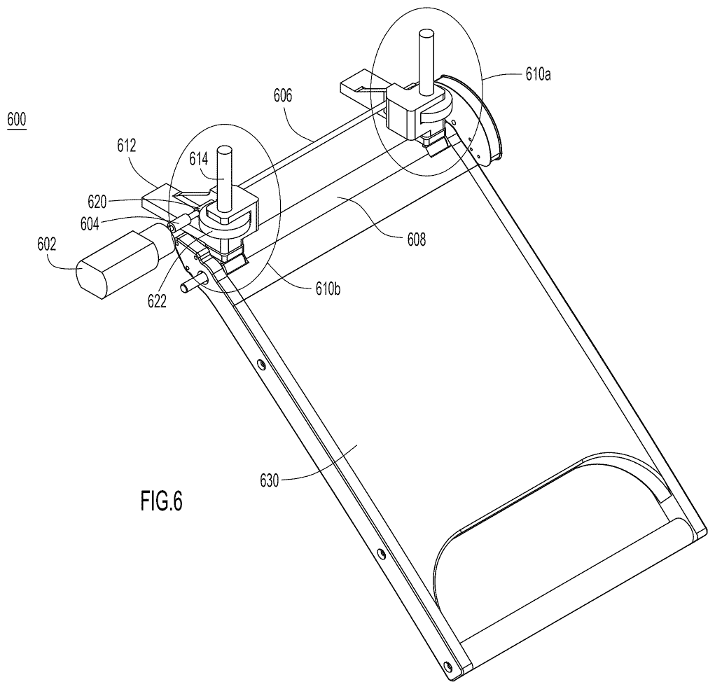

In one example embodiment, the driving mechanism 216 may be configured to lower along a set of rails (not shown) to adjust to a particular height of the PRM in the PRM device. In other words, in addition to sliding the overhead grab handle 210 into the deployed position 250, away from the outer wall 230, the driving mechanism 216 may adjust the height at which the overhead grab handle 210 will be deployed using an extension, an example of which is described below in connection with FIG. 6. The driving mechanism 216 is controlled by the control system 218.

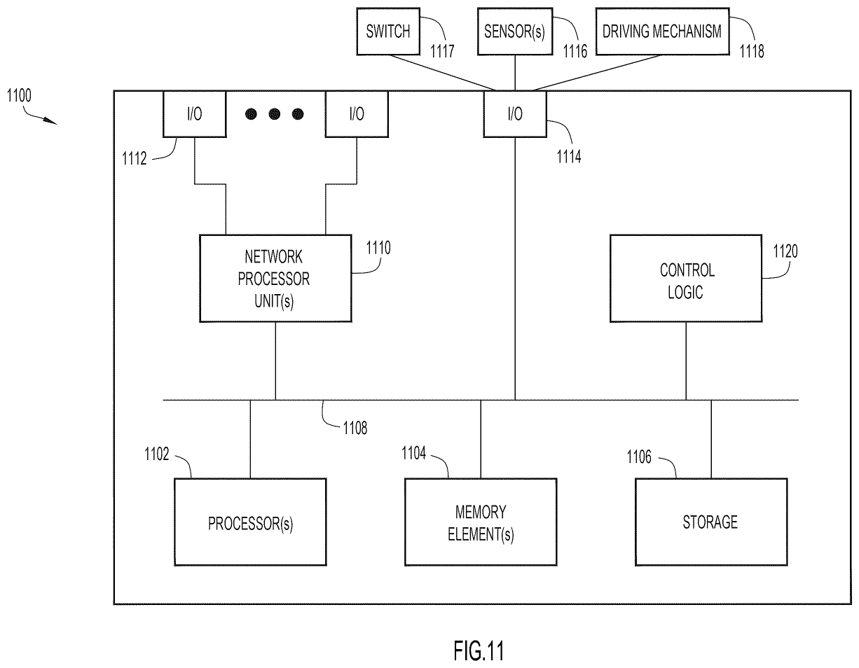

The control system 218 may be a controller, an example of which is described in FIG. 11. The control system 218 is configured to control the driving mechanism 216 to slide the overhead grab handle 210 along the arc 252. The control system 218 may include a processor or a microprocessor configured to obtain signals from various detectors/sensors/switches/buttons and send instructions, responsive to these signals, to the driving mechanism 216 and/or one of the safety systems. The control system 218 controls the driving mechanism 216 to actuate the motor to deploy or retract the overhead grab handle 210.

In one example embodiment, the control system 218 controls the driving mechanism 216 to deploy the overhead grab handle 210 (away from the outer wall 230) based on, or responsive to, the signal from the detector indicating the opening of the additional door panel of the door 118 (along with the main door panel to permit entry of the PRM in a PRM device) and a signal from an interior switch based on manipulations by a user. For example, the detector may be adjacent to or on the door 118 of FIG. 1 and based on opening of the additional door panel (along with the main door panel), a handle activation switch (an example of which is described below in connection with FIG. 3) is enabled to allow deployment of the overhead grab handle 210 from the stowed position 260 to the deployed position 250.

In one or more example embodiments, the control system 218 is positioned above the lavatory ceiling 220 (out of view). The control system 218 may be positioned next to the driving mechanism 216. The control system 218 may be formed integrally with the driving mechanism 216 as a single unit. The control system 218 and the driving mechanism 216 may further include safety systems within the unit to prevent injury to users when the system is in operation, examples of which are provided below.

As noted above, the control system 218 controls the driving mechanism 216 which slides the overhead grab handle 210, at the arc 252, between the deployed position 250 (away from the outer wall 230) and the stowed position 260 (shown in FIG. 2B). In the stowed position 260 (FIG. 2B), the overhead grab handle 210 is stowed within the handle stowage compartment 120 so as not to protrude from the outer wall 230 into the interior space formed by the housing. In one example embodiment, the handle stowage compartment 120 is formed inside a side wall of an interior space of the housing (the outer wall 230). That is, the side wall of the housing may include a cavity 232 for the handle stowage compartment 120. The handle stowage compartment 120 may include a stopper 234 to secure hold the overhead grab handle 210 in the stowed position 260. In one example embodiment, the stopper 234 may be a clip or an edge that holds the overhead grab handle 210 in place when in the stowed position 260.

The handle stowage compartment 120 is positioned at an angle with respect to the lavatory ceiling 220 i.e., along a slanted side wall (the outer wall 230). As such, the overhead grab handle 210 is stored along the outer wall 230 and in a diagonal position with respect to the lavatory ceiling 220. However, this is just one example. In another example embodiment, the overhead grab handle 210 may be stowed in the handle stowage compartment 120 and protrude from the outer wall 230 e.g., by one to four inches. In yet another example embodiment, the housing may exclude the handle stowage compartment 120 and simply include the stopper 234. As such, in the stowed position 260, the overhead grab handle 210 is secured or locked in place by the stopper 234 and abuts the slanted side wall (the outer wall 230) i.e., extends along and is in contact with the slanted side wall of the housing.

With continued reference to FIGS. 1, 2A and 2B, reference is now made to FIG. 3, which illustrates an interior space of a housing 300 in which the overhead handle system 130 of FIG. 1 includes one or more switches to activate deployment and retraction of an overhead grab handle, according to an example embodiment. The housing 300 forms an interior space 302 (e.g., the lavatory 100 of FIG. 1) having the toilet 144 of FIG. 1, an activation switch 310 that activates the overhead handle system 130 of FIG. 1, and a counter 312 with the sink 146 of FIG. 1. The housing 300 may further include a detector 314 on the door 118.

In one example embodiment, the activation switch 310 may be conveniently located at a shoulder height of a PRM user (e.g., a touchless switch) where the user does not have to physically touch the activation switch 310 to activate the overhead grab handle. The activation switch 310 provides both deployment and retraction of the overhead grab handle. Specifically, the activation switch 310 may be pressed by a PRM passenger, which generates or produce a first signal for a controller of the overhead handle system 130 indicative of the presence of the PRM device in the interior space 302. Based on or responsive to this first signal, the overhead handle system 130 slides the overhead grab handle at an arc into the deployed position. When the PRM passenger again presses the activation switch 310, the activation switch 310 generates a second signal and provides the generated second signal to the controller of the overhead handle system 130. Based on or responsive to this second signal, the overhead handle system 130 retracts the overhead grab handle into the stowed position.

This is just one example and the disclosure is not limited thereto. In another example embodiment, the activation switch 310 may be a mechanical switch to deploy and retract the overhead grab handle. The PRM users presses the activation switch 310 to deploy the overhead grab handle.

In yet another example embodiment, the activation switch 310 may operate in conjunction with the detector 314. That is, the activation switch 310 is enabled and disabled for use based on generated signals by the detector 314. A typical lavatory door in an aircraft is not sufficiently wide to admit a PRM device such as an OBW. To allow or permit entry of the PRM device, the door 118 includes at least two panels i.e., the first door panel 160a (main panel) and the second door panel 160b (additional panel). As such, the door 118 (main panel and additional panel) is made sufficiently wide to allow or permit entry of an OBW and/or other PRM device into the interior space 302. The door 118 may optionally include the detector 314 that detects opening of second door panel 160b (along with the first door panel 160a) to allow or permit entry of the PRM device into the interior space 302. The detector 314 generates or produces a signal indicating opening of the second door panel 160b. Based on or responsive to this signal, the overhead handle system 130 enables and/or disables the activation switch 310.

For example, responsive to a first signal from the detector 314, the overhead handle system 130 enables the activation switch 310 and based on a second signal from the detector 314, the overhead handle system 130 disables the activation switch 310. The first signal is indicative of the PRM device entering the interior space 302 and the second signal is indicative of the PRM device exiting the interior space 302. Disabling the activation switch 310 ensures that the grab handle is not deployed by curious non-PRM users. Non-PRM users (in standing positions) would not be able to deploy the grab handle. The activation switch 310 is enabled for use only by a PRM in a PRM device and is disabled when the interior space 302 is occupied by non-PRM users. This provides additional safety measures to avoid injuries to non-PRM users within the interior space 302.

In yet another example embodiment, the detector 314 may detect that the second door panel 160b is opened after being occupied and initiate the retraction of the overhead grab handle. In yet another example embodiment, the detector 314 may be configured to detect closing of the second door panel 160b as opposed to the opening of the second door panel 160b. As such, the retraction would occur after the PRM device exited the interior space 302.

The use and activation of the overhead grab handle, as well as the opening and closing of the second door panel 160b, conveys to the control system that a PRM user is using the lavatory. When the person leaves the lavatory, the second door panel 160b again has to be opened and closed. This signals to the control system to retract the overhead grab handle, if that has not been done by the PRM user in the lavatory. These are just some examples and the disclosure is not limited thereto. For example, the activation switch 310 may be positioned next to a flight attendant, which activates the activation switch 310 to assist a PRM user.

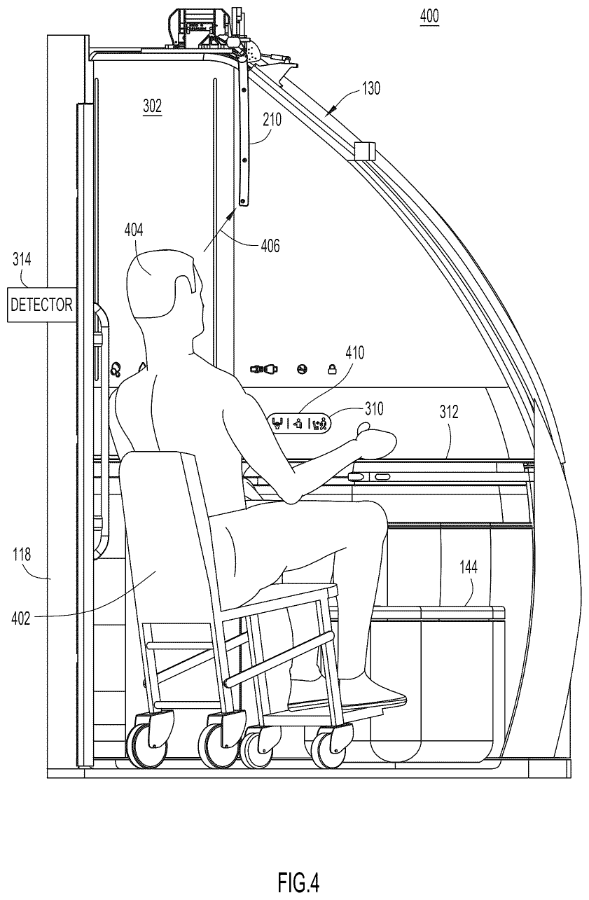

With continued reference to FIGS. 1, 2A, 2B, and 3, reference is now made to FIG. 4, which illustrates an environment 400 in which the overhead grab handle 210 of FIGS. 2A and 2B is deployed in a position easily accessible to a PRM in a PRM device, according to an example embodiment. The environment 400 includes a PRM 402 in a PRM device 404 and the overhead grab handle 210 of FIGS. 2A and 2B in a deployed position 406. The environment 400 further includes a height adjustment switch 410 that is configured to further vertically adjust the overhead grab handle 210 in the deployed position 406.

In the environment 400, the PRM 402 in the PRM device 404 enters the interior space 302. The detector 314 detects the opening of the second door panel 160b (not shown) and activates the activation switch 310. The activation switch 310 obtains input from the PRM 402 and generates a signal for the overhead handle system 130 to deploy the overhead grab handle 210 to protrude downwards to a height reachable by a person in a seated position. In the deployed position 406, the overhead grab handle 210 is locked in place and is easily accessible or reachable by the PRM 402 seated in the PRM device 404. For example, the overhead grab handle 210 extends vertically downwards to be approximately one to five feet above a person's head in a seated position.

If the PRM 402 seated in the PRM device 404 cannot reach the overhead grab handle 210, the PRM 402 may press the height adjustment switch 410 to further lower the overhead grab handle 210, examples of which are described in FIGS. 6, 7, 8A, 8B, 9A, and 9B. That is, the height adjustment switch 410 may be used to further adjust the overhead grab handle 210 in the deployed position (up or down) depending on the height of a person seating in the PRM device 404 and thus, become an extension of the overhead grab handle.

In the environment 400, the activation switch 310 and the height adjustment switch 410 inside the interior space 302 activate two different functions. The control system is programmed to first operate the overhead grab handle 210 deployment based on the activation switch 310. When the overhead grab handle 210 is deployed, the occupant (e.g., the PRM 402) may then decide if they need the overhead grab handle 210 to be further adjusted e.g., further lowered. That is, if the overhead grab handle 210 is difficult to reach for the user after it has been deployed, the user may use the height adjustment switch 410 to activate the height adjustment system, which moves the overhead grab handle 210 up or down by a predetermined height. For example, jack screws may become an extension of the overhead grab handle 210 when the overhead grab handle is moved down. Similarly, these jack screws may reduce the drop distance of the overhead grab handle 210 when moved up. Since the height of overhead grab handle 210 in the deployed position is likely to accommodate or assist most users in a seated position, only a small extension of approximately two to three inches may be helpful to accommodate or assist the shorter users.

The PRM 402 may grab/grasp the overhead grab handle 210 and rotate from the PRM device 404 onto the toilet 144. The PRM 402 does not need to push up towards a standing position because the overhead grab handle 210 is easily reachable in the seated position. As such, the overhead grab handle 210 makes it easier for the PRM users to use the lavatory. Additionally, the overhead grab handle 210 is a load bearing handle. The PRM 402 may simply hang on the overhead grab handle 210 (which is locked in place) and rotate onto the toilet 144 and back into the PRM device 404.

Retraction of the overhead grab handle 210 may be initiated either by using both of the switches (the height adjustment switch 410 followed by the activation switch 310) or just by the use of the activation switch 310. The microcontroller can be programmed to sequence the retraction with the use of only one switch.

With continued reference to FIGS. 1, 2A, 2B, 3 and 4, FIG. 5 illustrates components 500 of the overhead handle system 130 of FIG. 1 in more detail, according to an example embodiment. The components 500 include a gas spring and shock absorber 502, a load sensing device 504, limit switches 506, a gear and/or gear and belt reduction assembly 508, a controller 510, a rotational sensing device 512, a driving mechanism 514, and a grab handle 516. Some of the components 500 are installed above a ceiling panel 520 and may further abut or contact a top portion of a curved wall 522. A first hinge 530a and a second hinge 530b hold the grab handle 516.

In one example embodiment, there may be a standalone hinge that holds the grab handle 516 at a center thereof. In another example embodiment, the first hinge 530a may be a standalone hinge positioned at a first top corner of the grab handle 516 and the second hinge 530b may be adjacent to or integrally formed with the controller 510, the driving mechanism 514, the limit switches 506, the gear and belt reduction assembly 508, and/or the rotational sensing device 512. The second hinge 530b is positioned at a second top corner portion of the grab handle 516. This is provided by way of example only, and other hinge arrangements are within the scope of this disclosure. The number of hinges that attach to a frame of the ceiling or the ceiling panel 520 to support the grab handle 516 depends on a particular use case scenario. For example, each hinge may be formed with the spring damping system and/or an individual motor (a driving mechanism). The hinges hold a load bearing handle and lock it in place when the handle is deployed. In the deployed position, the grab handle 516 is at a height reachable by a person in a seated position e.g., in the PRM device.

The gas spring and shock absorber 502 is a spring damping mechanism that includes a spring and a shock absorber or a damping device, which may both be built into the same device (formed integrally therewith). The gas spring and shock absorber 502 prevents the grab handle 516 from flapping back and forth when the vehicle is moving from side to side, accelerating, and/or deaccelerating. The gas spring and shock absorber 502 may also help to slow down the deployment and retraction speed of the grab handle 516. In other words, the spring damping mechanism limits the speed of deployment and retraction of the grab handle 516 to provide a smoother motion for the grab handle 516.

The load sensing device 504 may be a safety device that includes sensors to prevent trapping or pinching of a person's hand/arm when the grab handle 516 is retracting. In one example, if the load sensed by sensors exceeds a predetermined threshold, the load sensing device 504 sends a signal to the controller 510 to stop retraction. The limit switches 506 are another set of safety devices to limit the amount of movement of the grab handle 516. The gear and belt reduction assembly 508 is configured to reduce the speed of an actuation motor (e.g., the driving mechanism 514) to allow the grab handle 516 to retract or deploy in a predetermined period of time e.g., approximately 3 seconds.

The controller 510 includes control electronics for the actuation motor and/or sensing system, an example of which is described with reference to FIG. 11. The controller 510 may include a memory and a processor or a microprocessor. The controller 510 is configured to receive signals from the load sensing device 504 and the limit switches 506, analyze the signals and control the actuation motor (the driving mechanism 514) to release or retract the grab handle 516. The controller 510 produces instructions to start/stop and change the speed of the driving mechanism 514. In fact, the rotational sensing device 512 determines the movement angle of the grab handle 516 that is sliding at an arc. This could be a linear device or a rotational device such as the rotational sensing device 512. The rotational sensing device 512 is configured to detect that the grab handle 516 is in the deployed or stowed position.

The load sensing device 504, the limit switches 506, the gear and belt reduction assembly 508, the controller 510, and the rotational sensing device 512 may be positioned on top of the ceiling panel 520 (hidden from view when the user is in an interior space). The first hinge 530a and the second hinge 530b are securely attached to the frame of the ceiling to withstand the weight of a PRM that may be holding onto the grab handle 516. Additionally, the first hinge 530a and the second hinge 530b securely retain the grab handle 516 in place in the deployed position to avoid flapping movements of the grab handle 516 while it is deployed. However, the first hinge 530a and the second hinge 530b are configured not to lock the grab handle 516 at the deployed position for safety but to allow some damp movements of the grab handle 516.

Reference is now made to FIG. 6, with continued reference to FIGS. 1, 2A, 2B, 3, 4 and 5. FIG. 6 illustrates components of a height adjustment assembly 600 that vertically adjusts a grab handle to accommodate a person in a seated position when the grab handle is already in a deployed position, according to an example embodiment.

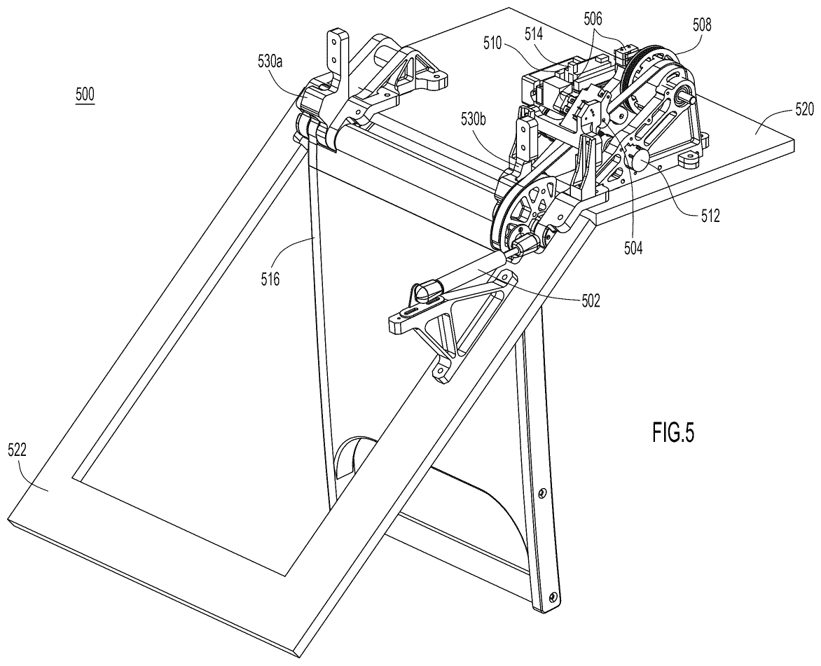

The height adjustment assembly 600 includes a servo motor 602, a coupling component 604, a driving shaft 606, and a rotary damper and spring 608 provided instead of the gas spring and shock absorber 502 of FIG. 5. The height adjustment assembly 600 further includes jack screw assemblies 610a-b including a first jack screw assembly 610a positioned at a first top corner portion of the deployed grab handle 630 and a second jack screw assembly 610b positioned at another top corner portion of the deployed grab handle 630. The jack screw assemblies 610a-b are adjacent to the hinges (shown in FIG. 5). Each jack screw assembly includes a load carrying structure 612, a jack screw 614, and a worm assembly having a worm 620 and a worm wheel 622.

In one example embodiment, the height adjustment assembly 600 is configured to vertically lower a deployed grab handle 630 to accommodate the height of a user in a seated position e.g., a PRM user in a PRM device. This is just an example and the disclosure is not limited thereto. In one example embodiment, the jack screws can serve to extend as well as shorten the deployed grab handle to better assist a PRM user in a PRM device e.g., to accommodate taller PRMs and/or PRMs seated in a higher PRM devices.

The height adjustment assembly 600 is activated via the height adjustment switch 410 of FIG. 4. The servo motor 602 is configured to drive the jack screw assemblies 630a-b (one at each side of the deployed grab handle 630) to further vertically lower or extend downwards the deployed grab handle 630 within a predetermined period of time and at a controlled speed. The coupling component 604 connects the jack screw assemblies 630a-b to the servo motor 602 to smoothly lower a grab handle.

The servo motor 602 is also controlled by the controller 510 of FIG. 5 e.g., a microcontroller. The controller 510 controls the motion of the deployed grab handle 630 from the stowed position to the deployed position and further controls the height adjustment assembly 600 to further extend the deployed grab handle 630 via the servo motor 602. The servo motor 602 attaches to the driving shaft 606 via the coupling component 604. The jack screw 614 of each jack screw assembly is configured to vertically move above the ceiling and below the ceiling such that the jack screw 614 becomes an extension for the deployed grab handle 630 when the jack screws are lowered below the ceiling. The jack screw 614 is securely attached to a frame of the housing and to the deployed grab handle 630.

The worm 620 of each of the jack screw assemblies 630a-b is connected to the driving shaft 606 and the coupling component 604 to attach to the servo motor 602. Rotation of the servo motor 602 rotates the worm wheel 622, which in turn raises or lowers the jack screw 614 depending on the rotational direction of the servo motor 602.

The height adjustment assembly 600 also includes limit switches or detectors to indicate the end points of motion for the microcontroller and the servo motor 602 to operate properly. For example, the rotary damper and spring 608 is configured to limit the speed of lowering the jack screw 614 in each of the jack screw assemblies 610a-b. The rotary damper and spring 608 ensures smooth motion of the deployed grab handle 630 e.g., without jerking, shaking, and/or vibrations.

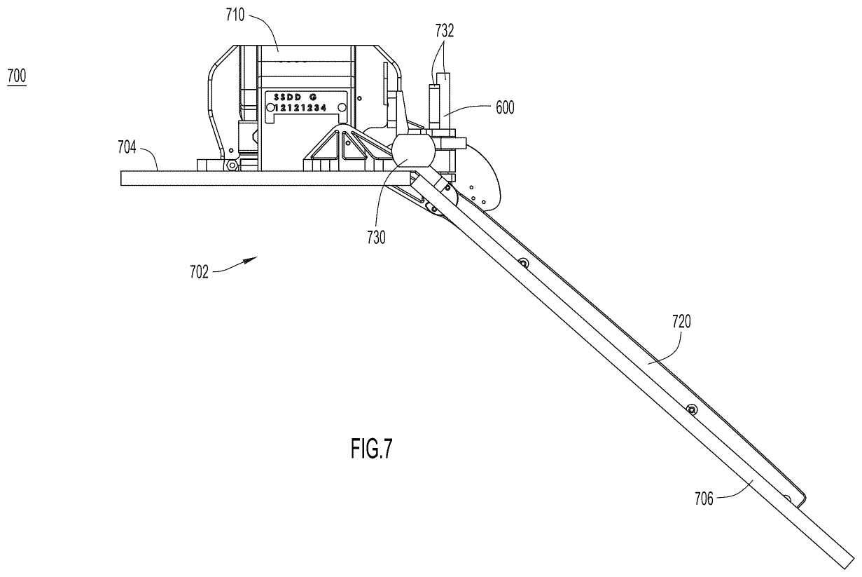

Turning now to FIG. 7, with continued reference to FIGS. 1, 2A, 2B, and 3-6, a side view is shown of an accommodation system 700 that includes the height adjustment assembly 600 of FIG. 6 and a grab handle in a stowed position, according to an example embodiment. The accommodation system 700 includes overhead grab handle control and drive unit 710, overhead grab handle 720, and the height adjustment assembly 600 with jack screw drive servo motor 730 and jack screws 732 and which is installed outside of a housing 702 that has a ceiling panel 704 and a slanted side wall 706.

Specifically, the overhead grab handle control and drive unit 710 is securely attached to the ceiling panel 704, near a corner formed by the ceiling panel 704 and the slanted side wall 706. The overhead grab handle 720 is aligned against the slanted side wall 706 and is in the stowed position. The height adjustment assembly 600 is controlled by a controller of the control and drive unit 710 and is positioned on top of the ceiling panel 704 and/or the slanted side wall 706. The height adjustment assembly 600 may be formed together with the control and drive unit 710. Specifically, a jack screw drive servo motor 730 of the height adjustment assembly 600 drives the jack screws 732. When the overhead grab handle 720 is in a stowed position, the jack screws 732 extend above the ceiling panel 704 and may align with the control and drive unit 710. The jack screws 732 are configured to vertically move above and below (up and down) the ceiling panel 704 by the jack screw drive servo motor 730.

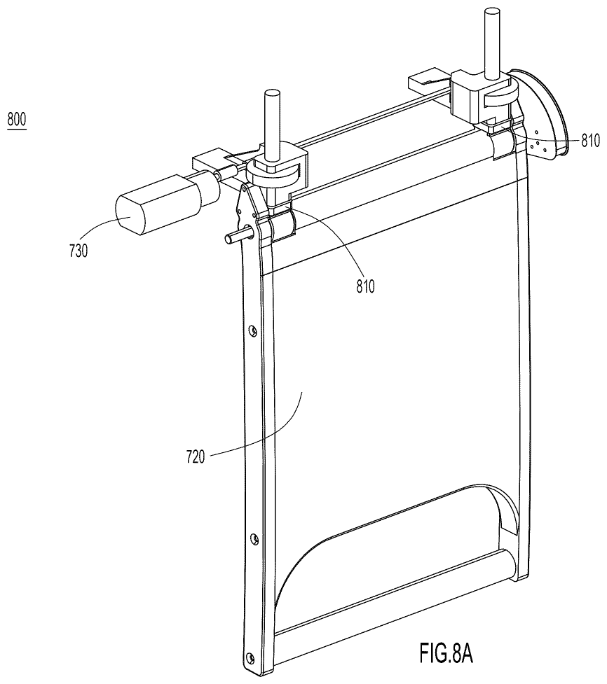

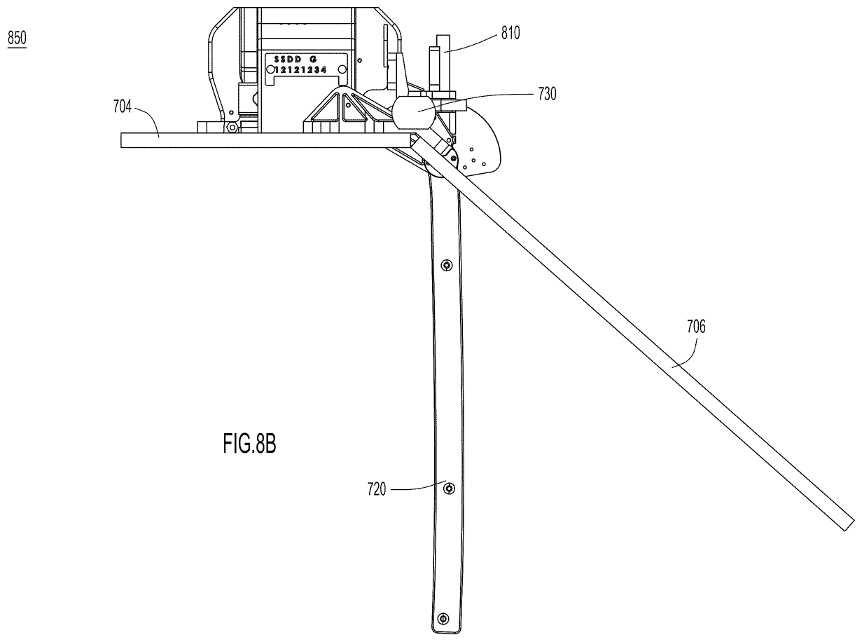

Referring now to FIGS. 8A and 8B, with continued reference to FIGS. 1, 2A, 2B and 3-7, diagrams are shown of a perspective view 800 and a side view 850, respectively, of the overhead grab handle 720 of FIG. 7 in a deployed position with a height adjuster set at a standard position, according to an example embodiment. The overhead grab handle 720 is in a deployed position in which it protrudes downwards from the ceiling panel 704 of a housing into an interior space, to be easily reachable by a person in a seated position. The height adjuster 810 such as the jack screws 732, are at a standard height.

In particular, the height adjuster 810 is positioned above the ceiling panel 704 at an angle with respect to the slanted side wall 706. In the standard position, while the overhead grab handle 720 is deployed for use, the height adjuster 810 is not deployed and does not further extend the overhead grab handle 720. That is, the height adjuster 810 is at a standard height. Additionally, the jack screw drive servo motor 730 is at rest (not used). The height adjuster 810 (jack screws) is configured to vertically move the overhead grab handle 720 but only when the overhead grab handle 720 is in the deployed position. One benefit of this arrangement is to ensure safety to users.

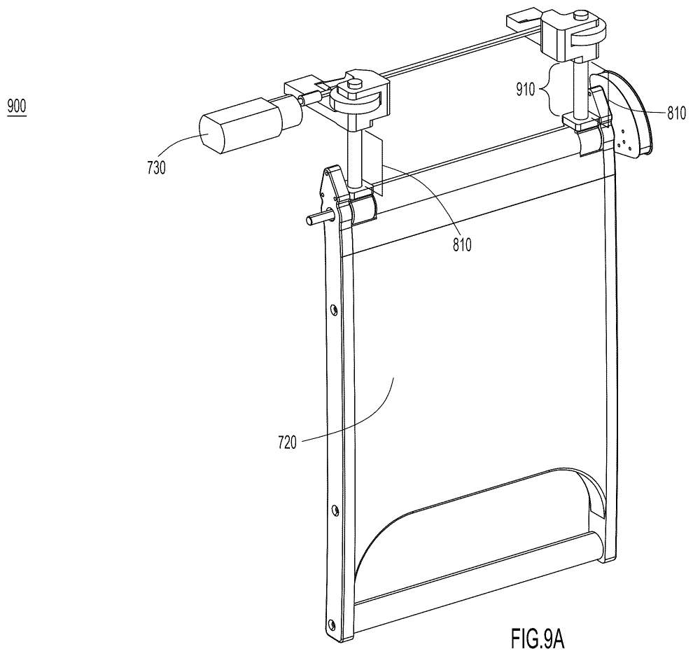

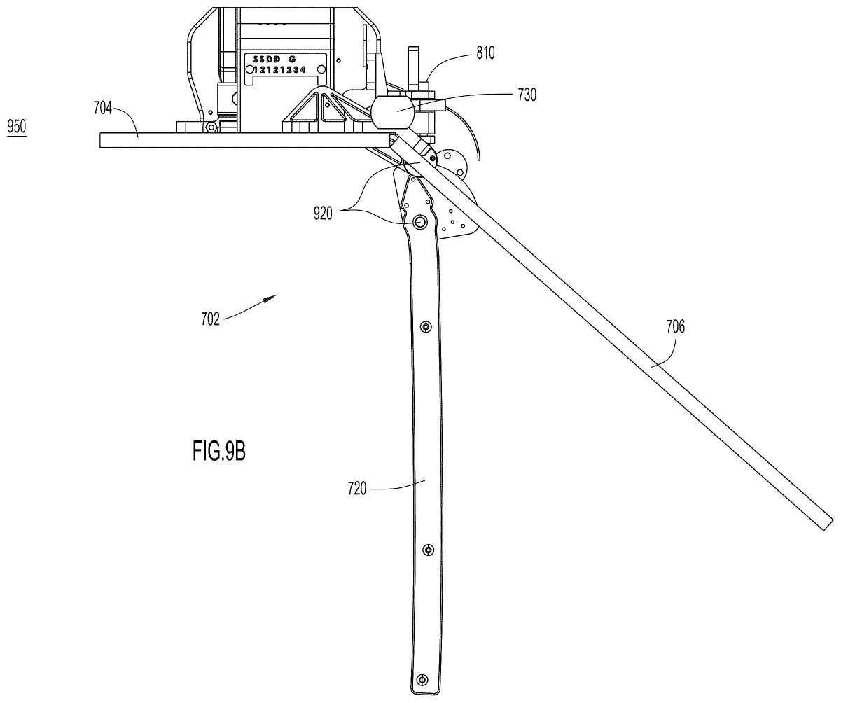

Referring now to FIGS. 9A and 9B, with continued reference to FIGS. 1, 2A, 2B, 3-7, 8A, and 8B, diagrams are shown of a perspective view 900 and a side view 950, respectively, of the overhead grab handle 720 of FIG. 7 in a deployed position with the height adjuster 810 set at an extended height, according to an example embodiment.

Specifically, the controller instructs the jack screw drive servo motor 730 to rotate, which vertically lowers the height adjuster 810 below the ceiling panel 704 using the worm assembly. The height adjuster 810 is in a down position (extended position). That is, the jack screw drive servo motor 730 moves the height adjuster 810 down such that the height adjuster 810 forms or becomes an extension 910 of the overhead grab handle 720. In the extend position or at the extended height, the height adjuster 810 further extends the overhead grab handle 720. The extension 910 may have an extension depth 920 of approximately 2-3 inches.

Once the overhead grab handle 720 is deployed and the occupant is still unable to reach the overhead grab handle 720, a second switch in the lavatory may be used to further lower the overhead grab handle 720 by approximately two to three inches. For example, this meets the requirements of a 5% female seated on the OBW and/or children. The height adjuster 810 allows the grab handle to be used by individuals with limited reach. The retraction of the overhead grab handle 720 may be performed by the height adjustment switch and/or the overhead grab handle retraction switch.

In summary, according to one or more example embodiments, a unique grab handle is provided, which is at a height that is easily reachable by a person in a seated position and which support a weight of a person. The grab handle is designed for special needs of PRMs in PRM devices and is adjustable to an individual PRM i.e., customizable for the individual use. A driving mechanism securely locks the grab handle in a stowage compartment when not in use for safety of non-PRM users. The driving mechanism drives the grab handle sliding it at an arc from the stowed position along a wall of the housing to a deployed position in which it protrudes downward from the ceiling (away from the wall) at a height accessible by various PRMs in various PRM devices. The PRM grabs the overhead handle and simply pivots between the PRM device and another seat without assistance.

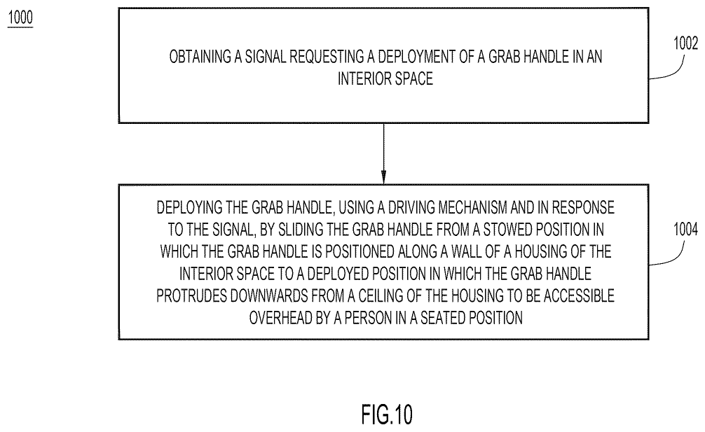

FIG. 10 is a flowchart illustrating a method 1000 of deploying a grab handle of FIGS. 1, 2A, 2B, 3-7, 8A, 8B, 9A, and/or 9B to accommodate a person in a seated position to transfer to another seat in an interior space, according to an example embodiment.

The method 1000 involves, at 1002, obtaining a signal requesting a deployment of a grab handle in an interior space.

The method 1000 further involves, at 1004, deploying a grab handle, using a driving mechanism and in response to the signal, by sliding the grab handle from a stowed position in which the grab handle is positioned along a wall of a housing of the interior space to a deployed position in which the grab handle protrudes downwards from a ceiling of the housing to be accessible overhead by a person in a seated position.

In one form, the method 1000 may further involve detecting, by a sensor positioned on a first door panel, an opening of the first door panel along with a second door panel and generating another signal indicating that the first door panel is being opened to enable a deployment of the grab handle by the driving mechanism in response to the signal requesting the deployment, which is obtained from an actuation button in the interior space.

In another form, the operation 1004 of deploying the grab handle may include sliding, along an arc, the grab handle away from a side wall of the housing into the deployed position.

In one instance, the method 1000 may include extending the grab handle in the deployed position downwards from the ceiling using a jack screw mechanism.

In another instance, the method 1000 may include locking in place, via one or more hinges, the grab handle in the stowed position.

FIG. 11 is a hardware block diagram of a controller 1100 that may control operations of an overhead handle system, according to various example embodiments. It should be appreciated that FIG. 11 provides only an illustration of one embodiment and does not imply any limitations with regard to the environments in which different embodiments may be implemented. Many modifications to the depicted environment may be made. The controller 1100 may be used for the controller component referred to above in connection with the various embodiments presented herein.

In at least one embodiment, controller 1100 may include one or more processor(s) 1102, one or more memory element(s) 1104, storage 1106, a bus 1108, one or more network processor unit(s) 1110 interconnected with one or more network input/output (I/O) interface(s) 1112, one or more I/O interface(s) 1114, and control logic 1120. In various embodiments, instructions associated with logic for controller 1100 can overlap in any manner and are not limited to the specific allocation of instructions and/or operations described herein. The network processor unit(s) 1110 and network I/O interfaces 1112 may not be part of the controller 1100 in embodiments where network communication with the controller 1100 is not needed or desired.

In at least one embodiment, processor(s) 1102 is/are at least one hardware processor configured to execute various tasks, operations and/or functions for controller 1100 as described herein according to software and/or instructions configured for controller 1100. Processor(s) 1102 (e.g., a hardware processor) can execute any type of instructions associated with data to achieve the operations detailed herein. Processor(s) 1102 may be configured to send instructions to and to receive instructions from or for various components such as sensor(s) 1116, driving mechanism 1118, and/or a switch 1117 that causes the deployment and/or retraction of the overhead grab handle. While only one switch (the switch 1117 is shown in FIG. 11), the disclosure is not limited thereto. In one or more example embodiments, there may be multiple switches. In one example, processor(s) 1102 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 1104 and/or storage 1106 is/are configured to store data, information, software, and/or instructions associated with controller 1100, and/or logic configured for memory element(s) 1104 and/or storage 1106. For example, any logic described herein (e.g., control logic 1120) can, in various embodiments, be stored for controller 1100 using any combination of memory element(s) 1104 and/or storage 1106. Note that in some embodiments, storage 1106 can be consolidated with one or more memory elements 1104 (or vice versa), or can overlap/exist in any other suitable manner.

In at least one embodiment, bus 1108 can be configured as an interface that enables one or more elements of controller 1100 to communicate in order to exchange information and/or data. Bus 1108 can be implemented with any architecture designed for passing control, data and/or information between processors, memory elements/storage, peripheral devices, and/or any other hardware and/or software components that may be configured for controller 1100. In at least one embodiment, bus 1108 may be implemented as a fast kernel-hosted interconnect, potentially using shared memory between processes (e.g., logic), which can enable efficient communication paths between the processes.

In various embodiments, network processor unit(s) 1110 may enable communication between controller 1100 and other systems, entities, etc., via network I/O interface(s) 1112 to facilitate operations discussed for various embodiments described herein. In various embodiments, network processor unit(s) 1110 can be configured as a combination of hardware and/or software, such as one or more Ethernet driver(s) and/or interface cards, Fibre Channel (e.g., optical) driver(s), and/or other similar network interface driver(s) now known or hereafter developed to enable communications between controller 1100 and other systems, entities, etc. to facilitate operations for various embodiments described herein. In various embodiments, network I/O interface(s) 1112 can be configured as one or more Ethernet port(s), Fibre Channel ports, and/or any other I/O port(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to controller 1100. For example, I/O interface(s) 1114 may provide a connection to external devices such as the sensor(s) 1116, the switch 1117, and/or the driving mechanism 1118 that drives the overhead grab handle. In some instances, external devices can also include portable computer readable (non-transitory) storage media such as database systems, thumb drives, portable optical or magnetic disks, and memory cards.

In various embodiments, control logic 1120 can include instructions that, when executed, cause processor(s) 1102 to perform operations, which can include, but not be limited to, providing overall control operations of controller; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, a system is provided. The system includes a grab handle and a driving mechanism. The grab handle is configured to be attached to a ceiling of a housing and to move from a stowed position in which the grab handle is positioned along a wall of the housing to a deployed position in which the grab handle is configured to extend vertically from the ceiling of the housing to be accessible overhead by a person in a seated position. The driving mechanism is configured to slide the grab handle between the stowed position and the deployed position.

In one instance, the system may further include a controller configured to control the driving mechanism to slide the grab handle along an arc. The controller may further be configured to be positioned above the ceiling of the housing.

According to one or more example embodiments, the system may further include a detector configured to detect an opening of a first door panel that is configured to open along with a second door panel to allow entry of the person seated in a person with reduced mobility (PRM) device into an interior space formed by the housing, the detector configured to produce a signal indicating opening of the first door panel. The system may further include an interior switch configured to be manipulated by the person to request a deployment of the grab handle. The controller may be configured to control the driving mechanism to deploy the grab handle based on the signal from the detector indicating the opening of the first door panel and based on the interior switch being manipulated by the person.

In another instance, the system may further include a stowage compartment, formed inside a side wall of an interior space of the housing, configured to store the grab handle along the side wall and in a diagonal position with respect to the ceiling.

According to one or more example embodiments, the grab handle may be configured to not protrude from the side wall into the interior space in the stowed position.

In one form, the system may further include one or more hinges configured to attach to a frame of the ceiling and to support the grab handle.

According to one or more example embodiments, the one or more hinges may include a first standalone hinge positioned at a first top corner portion of the grab handle and a second hinge that is adjacent to the driving mechanism and is positioned at a second top corner portion of the grab handle.

In one instance, the system may include a spring damping mechanism configured to limit a speed of deployment and retraction of the grab handle.

In another instance, the driving mechanism may include an actuation motor. The system may further include a gear and belt reduction assembly configured to reduce a speed of the actuation motor such that the grab handle is retracted and deployed within a predetermined period of time.

According to one or more example embodiments, the system may further include a height adjustment assembly configured to vertically lower the grab handle in the deployed position from the ceiling further downward.

In one form, the height adjustment assembly may further include a plurality of jack screws configured to vertically move above the ceiling and below the ceiling and a drive servo motor configured to move the plurality of jack screws up and down such that the plurality of jack screws become an extension for the grab handle when the plurality of jack screws are lowered below the ceiling.

In one instance, the plurality of jack screws may be securely attached to a frame of the housing and to the grab handle.

According to one or more example embodiments, the system may further include a switch configured to be activated by a user to initiate a deployment and/or a retraction of the grab handle and a controller, coupled to the switch. The controller may be configured to control the driving mechanism to slide the grab handle along an arc to deploy the grab handle and/or to retract the grab handle.

In yet another example embodiment, an accommodation system is provided. The accommodation system includes a housing having a plurality of side walls, a ceiling, and a seat in an interior space formed by the housing and an overhead grab handle mechanism. The overhead grab handle mechanism includes a grab handle attached to the ceiling and a driving mechanism that slides the grab handle between a stowed position in which the grab handle is positioned along one of the plurality of side walls of the housing and a deployed position in which the grab handle protrudes downwards from the ceiling to be accessible by a person in a seated position.

In one form, in the deployed position, the grab handle may protrude downwards to a height reachable by the person seated in a person with reduced mobility (PRM) device to assist the person to transfer from the PRM device to the seat.

In another form, the housing may include a main door panel configured to open to permit entry of the person into the interior space and an additional door panel configured to open along with the main door panel for an entry of a person with reduced mobility (PRM) device into the interior space. The overhead grab handle mechanism may further include a detector configured to detect an opening of the additional door panel. The detector may be configured to produce a signal indicating opening of the additional door panel. The driving mechanism may be responsive to the signal to allow for a deployment of the grab handle.

In another example embodiment, an apparatus is provided that includes components and operations explained above.

The programs described herein (e.g., control logic 1120) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, controller 1100 as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1106 and/or memory elements(s) 1104 can store data, software, code, instructions (e.g., processor instructions), logic, parameters, combinations thereof, and/or the like used for operations described herein. This includes the storage 1106 and/or memory elements(s) 1104 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and’ one or more of can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Accordingly, the appended claims should be construed broadly and, in a manner, consistent with the scope of the present disclosure.

What is claimed is:

1. A system comprising:
a grab handle configured to be attached to a ceiling of a housing and to move from a stowed position in which the grab handle is positioned along a wall of the housing to a deployed position in which the grab handle is configured to extend vertically from the ceiling of the housing to be accessible overhead by a person in a seated position; and
a driving mechanism configured to slide the grab handle between the stowed position and the deployed position.

2. The system of claim 1, further comprising:
a controller configured to control the driving mechanism to slide the grab handle along an arc, wherein the controller is further configured to be positioned above the ceiling of the housing.

3. The system of claim 2, further comprising:
a detector configured to detect an opening of a first door panel that is configured to open along with a second door panel to allow entry of the person seated on a person with reduced mobility (PRM) device into an interior space formed by the housing, the detector configured to produce a signal indicating the opening of the first door panel; and
an interior switch configured to be manipulated by the person to request a deployment of the grab handle,
wherein the controller is configured to control the driving mechanism to deploy the grab handle based on the signal from the detector indicating the opening of the first door panel and based on the interior switch being manipulated by the person.

4. The system of claim 1, further comprising:
a stowage compartment, formed inside a side wall of an interior space of the housing, configured to store the grab handle along the side wall and in a diagonal position with respect to the ceiling.

5. The system of claim 4, wherein the grab handle is configured to not protrude from the side wall into the interior space in the stowed position.

6. The system of claim 1, further comprising:
one or more hinges configured to attach to a frame of the ceiling and to support the grab handle.

7. The system of claim 6, wherein the one or more hinges include a first standalone hinge positioned at a first top corner portion of the grab handle and a second hinge that is adjacent to the driving mechanism and is positioned at a second top corner portion of the grab handle.

8. The system of claim 7, further comprising:
a spring damping mechanism configured to limit a speed of deployment and retraction of the grab handle.

9. The system of claim 1, wherein the driving mechanism includes an actuation motor, and further comprising:
a gear and belt reduction assembly configured to reduce a speed of the actuation motor such that the grab handle is retracted and deployed within a predetermined period of time.

10. The system of claim 1, further comprising:
a height adjustment assembly configured to vertically lower the grab handle in the deployed position from the ceiling further downward.

11. The system of claim 10, wherein the height adjustment assembly includes:
a plurality of jack screws configured to vertically move above the ceiling and below the ceiling; and
a drive servo motor configured to move the plurality of jack screws up and down such that the plurality of jack screws become an extension for the grab handle when the plurality of jack screws are lowered below the ceiling.

12. The system of claim 11, wherein the plurality of jack screws are securely attached to a frame of the housing and to the grab handle.

13. The system of claim 1, further comprising:
a switch configured to be activated by a user to initiate a deployment and/or a retraction of the grab handle; and
a controller, coupled to the switch, and configured to control the driving mechanism to slide the grab handle along an arc to deploy the grab handle and/or to retract the grab handle.

14. A method comprising:
obtaining a signal requesting a deployment of a grab handle in an interior space; and
deploying the grab handle, using a driving mechanism and in response to the signal, by sliding the grab handle from a stowed position in which the grab handle is positioned along a wall of a housing of the interior space to a deployed position in which the grab handle protrudes downwards from a ceiling of the housing to be accessible overhead by a person in a seated position.

15. The method of claim 14, further comprising:
detecting, by a sensor positioned on a first door panel, an opening of the first door panel along with a second door panel; and
generating another signal indicating that the first door panel is being opened to enable the deployment of the grab handle by the driving mechanism in response to the signal requesting the deployment, which is obtained from an actuation button in the interior space.

16. The method of claim 14, wherein deploying the grab handle includes:
sliding, along an arc, the grab handle away from a side wall of the housing into the deployed position.

17. The method of claim 16, further comprising:
extending the grab handle in the deployed position downwards from the ceiling using a jack screw mechanism.

18. The method of claim 14, further comprising:
locking in place, via one or more hinges, the grab handle in the stowed position.

19. An accommodation system comprising:
a housing having a plurality of side walls, a ceiling, and a seat in an interior space formed by the housing; and
an overhead grab handle mechanism comprising a grab handle attached to the ceiling and a driving mechanism that slides the grab handle between a stowed position in which the grab handle is positioned along one of the plurality of side walls of the housing and a deployed position in which the grab handle protrudes downwards from the ceiling to be accessible by a person in a seated position.

20. The accommodation system of claim 19, wherein, in the deployed position, the grab handle protrudes downwards to a height reachable by the person seated in a person with reduced mobility (PRM) device to assist the person to transfer from the PRM device to the seat.

21. The accommodation system of claim 19, wherein the housing includes a main door panel configured to open to permit an entry of the person into the interior space and an additional door panel configured to open along with the main door panel for the entry of the person seated in a person reduced mobility (PRM) device into the interior space,
wherein the overhead grab handle mechanism further includes a detector configured to detect an opening of the additional door panel, the detector configured to produce a signal indicating the opening of the additional door panel, and wherein the driving mechanism is responsive to the signal to allow a deployment of the grab handle.
